(19) United States
(12) Patent Application Publication
(10) Pub. No.: US 2016/0356619 A1
(43) Pub. Date: Dec. 8, 2016

(54) VEHICLE NAVIGATION APPARATUS

(71) Applicant: DENSO CORPORATION, Aichi (JP)

(72) Inventor: Keisuke NISHIO, Kariya-city (JP)

(21) Appl. No.: 15/117,483

(22) PCT Filed: Jan. 29, 2015
(86) PCT No.: PCT/JP2015/000389

§ 371 Date: Aug. 9, 2016

(30) Foreign Application Priority Data
Feb. 14, 2014 (JP) 2014-026560

(51) Int. Cl. G01C 21/36

(52) U.S. Cl. CPC G01C 21/3629; H04L 67/12

(57) ABSTRACT

A vehicle navigation apparatus comprises: a recording medium reproduction portion that reproduces a recording medium to which image data and audio data are recorded; a CPU that performs a navigation function, processes the image data, and allows a display portion to display the image data; a sampling rate conversion IC that converts a sampling rate of the audio data; an encryption IC that encrypts the audio data; and an audio output portion that outputs the audio data outside the vehicle navigation apparatus. The recording medium reproduction portion outputs the audio data in two types of signal forms. The CPU performs a conversion process on the audio data having a lower data throughput, and outputs processed data to the encryption IC. The sampling rate conversion IC performs a sampling rate conversion process on the audio data having a higher data throughput, and outputs processed data to the encryption IC.

### CROSS REFERENCE TO RELATED APPLICATION

The present application is based on Japanese Patent Application No. 2014-26560 filed on Feb. 14, 2014, the disclosure of which is incorporated herein by reference.

### TECHNICAL FIELD

The present disclosure relates to a vehicle navigation apparatus including a recording medium reproduction portion.

### BACKGROUND ART

A vehicle navigation apparatus may include a DVD (Digital Versatile Disk) reproduction function. Recently, many audios reproduced from a DVD may include a multichannel format such as 5.1ch. Accordingly, an audio visual (AV) system installed in a vehicle compartment may be configured as a multichannel-adaptive system. Further, different reproduction environments may be used for a front-seat side and a rear-seat side in the vehicle compartment. A DVD reproduction portion of an automobile navigation system may separately output a predetermined audio signal for the front seat and a predetermined audio signal for the rear seat. Patent literature 1 discloses an example of an automobile AV transmission system.

The inventor of the present application has found the following regarding a navigation apparatus.

A CPU to comprehensively control a navigation apparatus needs to process video and audio reproduced from a DVD in addition to ordinary navigation processing in order to comply with the above mentioned configuration. It increases processing loads on the CPU. Increasing processing loads on the CPU may accordingly require using a CPU having a high processing capacity or separately providing a LSI for signal processing. However, such a straightforward countermeasure may unfavorably increase costs of the navigation apparatus.

### PRIOR ART LITERATURES

### Patent Literature

Patent Literature 1: JP 2008-154151 A

### SUMMARY OF INVENTION

It is an object of the present disclosure to provide a vehicle navigation apparatus capable of minimizing costs and processing two types of audio data in a configuration that allows a recording medium reproduction portion to output two types of audio.

According to a vehicle navigation apparatus according to one example of the present disclosure, a CPU performs a process to implement a navigation function, processes the image data reproduced by the recording medium reproduction portion, and allows a display portion to display the image data. The vehicle navigation apparatus is provided with a sampling rate conversion IC that converts a sampling rate of the audio data reproduced by the recording medium reproduction portion into a particular value, and an encryption IC that encrypts the audio data whose sampling rate has been converted into the particular value.

The recording medium reproduction portion outputs the audio data in two types of signal forms corresponding to two different reproduction environments. The CPU performs a conversion process on the audio data having a lower data throughput of the two types of signal forms, the conversion process being similar to a process performed by the sampling rate conversion IC, and outputs processed data to the encryption IC (11). The sampling rate conversion IC performs a sampling rate conversion process on the audio data having a higher data throughput of the two types of signal forms, and outputs processed data to the encryption IC (11).

In the vehicle navigation according to an example of the present disclosure, a sampling rate conversion IC that has been added processes audio data whose data throughput is higher while an existing CPU processes audio data whose data throughput is lower. Accordingly, it may be possible to adopt a one-channel input channel as the sampling rate conversion IC. An encryption IC exclusively encrypts two types of audio data whose sampling rate is converted. A processing load during recording medium reproduction is distributed among the CPU, the sampling rate conversion IC, and the encryption IC. Accordingly, it may be possible to minimize an increase in costs and process audio data output in two types of signal forms.

### BRIEF DESCRIPTION OF DRAWINGS

The above and other aspects, features and advantages of the present disclosure will become more apparent from the following detailed description made with reference to the accompanying drawings. In the drawings:

FIG. 1 is a functional block diagram illustrating a configuration of a vehicle navigation apparatus according to an embodiment of the present disclosure; and

FIG. 2 is a diagram illustrating an example of placing several speakers in a vehicle compartment.

### DESCRIPTION OF EMBODIMENTS

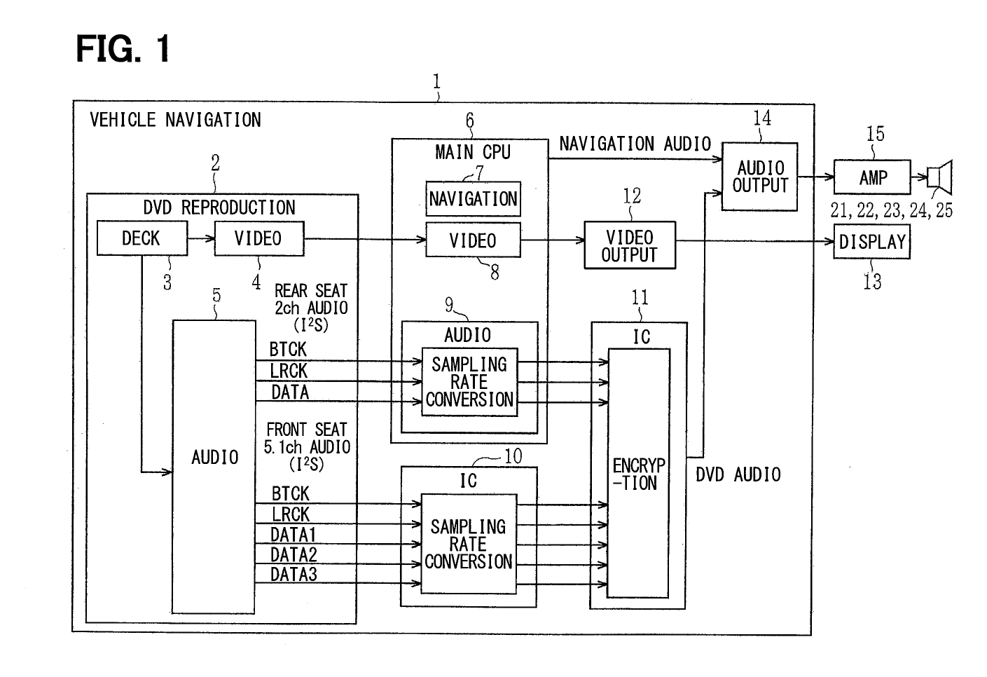

As illustrated in FIG. 1, a vehicle navigation apparatus 1 includes a DVD reproduction portion 2. The DVD reproduction portion 2 includes a DVD deck 3, a DVD video processing circuit 4, and a DVD audio processing circuit 5. Though not illustrated, the DVD deck 3 includes a mechanism to load/unload a DVD, a DVD drive, a pickup portion, or the like. The DVD deck 3 rotatively drives a loaded DVD, reads a recorded digital signal using a laser beam, and reproduces a video signal and an audio signal.

The DVD reproduction portion 2 corresponds to an example of a recording medium reproduction portion. The DVD corresponds to an example of a recording medium.

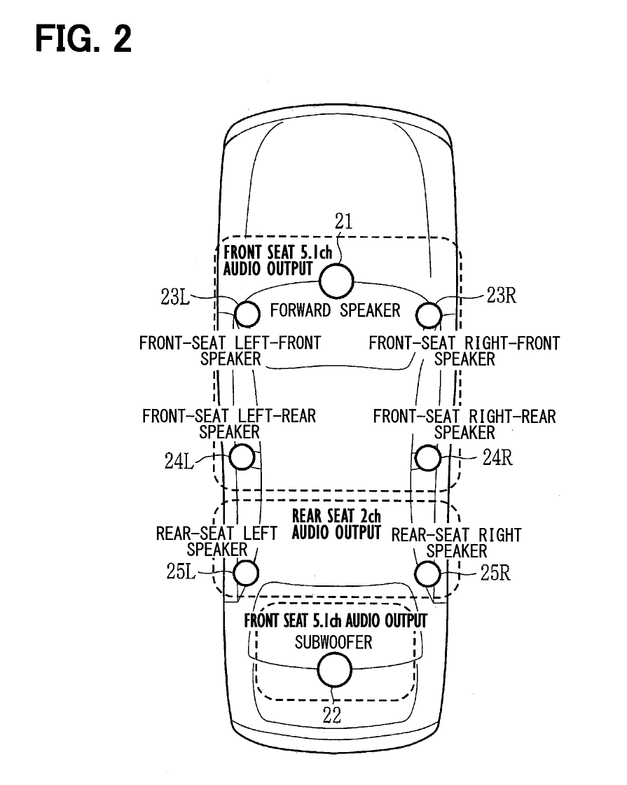

As illustrated in FIG. 2, audio signal reproduction environments are independently specified at the front-seat side and the rear-seat side in a vehicle compartment where the navigation apparatus 1 is installed. The front-seat side is configured as 5.1ch (5.1 channel surround sound: front L, front R, rear L, rear R, center, and subwoofer). The rear-seat side is configured as 2ch (L and R). A forward (center) speaker 21 is placed at the center forward of the vehicle compartment. A subwoofer 22 is placed at the center backward of the vehicle compartment. A front-seat left-front (front L) speaker 23L is placed at the left forward of the vehicle compartment. A front-seat right-front (front R) speaker 23R is placed at the right forward of the vehicle compartment. A front-seat left-rear (rear L) speaker 24L is placed at the left near the center of the vehicle compartment. A front-seat right-rear (rear R) speaker 24R is placed at the right near the center of the vehicle compartment. A rear-seat left (L) speaker 25L is placed at the left backward of the vehicle compartment. A rear-seat right (R) speaker 25R is placed at the right backward of the vehicle compartment.

Again, return to FIG. 1. The DVD video processing circuit 4 is supplied with an audio signal from the DVD deck 3. In accordance with the above-mentioned two types of reproduction environment, the DVD video processing circuit 4 is configured to output the supplied audio signal by splitting it into a 5.1ch audio signal at the front-seat side and a 2ch audio signal at the rear-seat side in advance. The signals are output in compliance with an I2S (Inter-IC Sound) format, for example. A 5.1ch audio signal at the front-seat side is output using five signal lines, BTCK (bit clock), LRCK (LR clock), and DATA1 through DATA3. A 2ch audio signal at the rear-seat side is output using three signal lines, BTCK, LRCK, and DATA.

A main CPU 6 comprehensively controls the navigation apparatus 1. The main CPU 6 includes a navigation processing portion 7 to perform ordinary navigation processing, a video processing portion 8 to process video signal, and an audio processing portion 9 to process audio signal. The navigation apparatus 1 includes a sampling rate conversion IC 10 and an encryption IC 11 independently of the main CPU 6.

The main CPU 6 determines a position of a vehicle based on a GPS signal received via an unshown GPS (Global Positioning System) reception portion in the navigation processing portion 7, or retrieves routes on map data or the like. The video processing portion 8 processes a video signal supplied from the DVD video processing circuit 4 in the DVD reproduction portion 2, and outputs the processed video signal to a display 13 via a video output circuit 12 to display an image. A medium to record map data to be displayed on the display 13 for navigation is available as, for example, a DVD reproduced by a DVD deck (unshown) provided separately from the DVD deck 3. Alternatively, the recording medium may be a hard disk (storage device) or an SD card (registered trademark), provided separately from the DVD.

The display 13 corresponds to an example of a display portion. The hard disk corresponds to an example of the storage device. The GPS is an example of a positioning system.

The DVD reproduction portion 2 supplies the audio processing portion 9 with a 2ch audio signal at the rear-seat side. The audio processing portion 9 applies sampling rate conversion (SRC, for example 96 kHz) to the audio signal, and outputs the audio signal to the encryption IC 11. The DVD reproduction portion 2 supplies the sampling rate conversion IC 10 with a 5.1ch audio signal at the front-seat side. The sampling rate conversion IC 10 similarly applies sampling rate conversion to the audio signal and outputs the audio signal to the encryption IC 11.

As an example of specifications of the main CPU 6, the main CPU 6 includes three 32-bit cores each operating at the maximum operating frequency of 400 MHz. Each core includes an instruction cache memory and a data cache memory whose size is 32 kilobytes each.

The encryption IC 11 performs an encryption process (for example, Digital Transmission Content Protection; DTCP) to protect an input audio signal, and allows an audio output circuit 14 to output the audio signal to an amplifier 15 outside the navigation apparatus 1. The navigation processing portion 7 outputs an audio signal for navigation. The encryption IC 11 similarly allows the audio output circuit 14 to output this audio signal to the amplifier 15. The audio output circuit 14 may be configured as a communication interface such as MOST (Media Oriented System Transport), for example. An audio signal input to the amplifier 15 is decoded. Corresponding signals are amplified and are output to the speakers 21 through 25.

The audio output circuit 14 corresponds to an example of an audio output portion.

According to the embodiment as described above, the main CPU 6 of the navigation apparatus 1 performs processes to implement the navigation function, processes image data reproduced by the DVD reproduction portion 2, and allows the display 13 to display the image data. The navigation apparatus 1 separately includes the sampling rate conversion IC 10 and the encryption IC 11. The sampling rate conversion IC 10 converts a sampling rate of audio data into a particular value. The encryption IC 11 encrypts converted audio data.

The DVD reproduction portion 2 outputs audio data in two types of signal forms corresponding to the two different reproduction environments. The main CPU 6 applies a conversion process to one of the two types of signal forms whose data throughput is lower than the other. This conversion process is similar to that performed by the sampling rate conversion IC 10. The main CPU 6 outputs the processed data to the encryption IC 11. The sampling rate conversion IC 10 applies a sampling rate conversion process to one of the two types of signal forms whose data throughput is higher than the other. The sampling rate conversion IC 10 outputs the processed data to the encryption IC 11. The audio data encrypted by the encryption IC 11 is output outside the navigation apparatus 1 via the audio output circuit 14.

The additional sampling rate conversion IC 10 processes audio data whose data throughput is higher while the existing main CPU 6 processes audio data whose data throughput is lower. A one-channel input channel suffices for the sampling rate conversion IC 10. The encryption IC 11 exclusively encrypts two types of audio data whose sampling rate is converted. A processing load during DVD reproduction is distributed among the main CPU 6, the sampling rate conversion IC 10, and the encryption IC 11.

The sampling rate conversion IC 10 and the encryption IC 11 are added to process minimal functions outside while maintaining existing specifications of the main CPU 6. This can minimize an increase in costs and process audio data output in two types of signal forms.

As an example of the present embodiment, one of the two types of signal forms corresponds to the reproduction environment at the front-seat side. The other of the two types of signal forms corresponds to the reproduction environment at the rear-seat side. The audio reproduction environment in a vehicle compartment is often configured differently at the front-seat side and at the rear-seat side. The embodiment can comply with the two types of reproduction environment. One of the two types of signal forms corresponds to 2ch audio data, and the other corresponds to 5.1ch audio data, so that it may be possible to comply with the two types of signal forms recently used for many DVDs.

The present disclosure is not limited to the embodiments described above or illustrated in the drawings but may be otherwise modified or enhanced as follows.

The specification of the main CPU 6 is provided as an example. Necessary specifications may be selected as needed in accordance with respective designs.

The recording medium is not limited to a DVD, but may be available as a Blue-ray disk (registered trademark), for example. The recording medium stores image data and audio data. The audio data may be stored in two types of signal forms corresponding to the two different reproduction environments.

Similarly to a DVD, 2ch audio data and 5.1ch audio data may be reproduced simultaneously when the DVD deck 2 can reproduce a hybrid SACD (registered trademark) including the multichannel format.

The two types of signal forms are not limited to 2ch and 5.1ch audio data but may be applicable to two forms that make a difference in data throughput.

The signal forms do not necessarily correspond to the reproduction environments at the front-seat side and the rear-seat side. No limitation is placed on the two types of signal forms except the condition that the data throughputs differ.

While the embodiments, the configurations, and the modes according to the present disclosure have been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle navigation apparatus comprising:
a recording medium reproduction portion that reproduces a recording medium to which an image data and an audio data are recorded;
a CPU that performs a process to implement a navigation function, processes the image data reproduced by the recording medium reproduction portion, and allows a display portion to display the image data;
a sampling rate conversion IC that converts a sampling rate of the audio data reproduced by the recording medium reproduction portion into a particular value;
an encryption IC that encrypts the audio data whose sampling rate has been converted into the particular value; and
an audio output portion that outputs the audio data encrypted by the encryption IC outside the vehicle navigation apparatus,
wherein:
the recording medium reproduction portion outputs the audio data in two types of signal forms corresponding to two different reproduction environments;
the CPU performs a conversion process on the audio data having a lower data throughput of the two types of signal forms, the conversion process being similar to a process performed by the sampling rate conversion IC, and outputs processed data to the encryption IC; and
the sampling rate conversion IC performs a sampling rate conversion process on the audio data having a higher data throughput of the two types of signal forms, and outputs processed data to the encryption IC.

2. The vehicle navigation apparatus according to claim 1, wherein:
a first signal form of the two types of signal forms corresponds to reproduction environment at a front-seat side; and
a second signal form corresponds to reproduction environment at a rear-seat side.

3. The vehicle navigation apparatus according to claim 1, wherein:
a first signal form is available as 2ch audio data; and
a second signal form is available as 5.1ch audio data.

4. The vehicle navigation apparatus according to claim 1, wherein:
one signal form of the two types of signal forms corresponds to reproduction environment at a front-seat side and is available as 5.1ch audio data; and
an other signal form of the two types corresponds to reproduction environment at a rear-seat side and is available as 2ch audio data.
